(19) United States
(12) Patent Application Publication
(10) Pub. No.: US 2019/0176181 A1
(43) Pub. Date: Jun. 13, 2019

(54) PAINTING BOOTH

(71) Applicant: TRINITY INDUSTRIAL CORPORATION, Toyota-shi, Aichi (JP)

(72) Inventors: Ryota SAITO, Toyota-shi (JP); Hideaki HARA, Obu-shi (JP)

(73) Assignee: TRINITY INDUSTRIAL CORPORATION, Toyota-shi, Aichi (JP)

(21) Appl. No.: 15/772,786

(22) PCT Filed: Sep. 14, 2016
(86) PCT No.: PCT/JP2016/077093

§ 371 Date: May 1, 2018

(30) Foreign Application Priority Data
Nov. 12, 2015 (JP) 2015-222285

(51) Int. Cl. B05B 16/60; B05B 13/04; B05B 14/44; B05B 16/40; B05B 12/18

(52) U.S. Cl. CPC B05B 16/60; B05B 13/0452; B05B 12/18; B05B 16/405; B05B 14/44

(57) ABSTRACT

A painting booth includes a pair of first inner surfaces facing each other in a first horizontal direction with a painting treatment area therebetween, an air supply duct arranged at the center, in the first horizontal direction, of the upper part of the inside of the painting booth, and an air blow-out port which is formed ranging from a central part to both side parts, in the first horizontal direction, of the air supply duct and which blows out air right downward at the central part and blows out air in an obliquely downward direction of each of the first inner surfaces on the both side parts.

### TECHNICAL FIELD

The present invention relates to a painting booth which has, in the inside thereof, a painting treatment area where a workpiece is coated with atomized paint, and in which air flows down from an air supply unit provided at the upper part of the inside so as to remove atomized paint not attached to the workpiece.

### BACKGROUND ART

As a painting booth of this type, there is conventionally known a painting booth in which an entire ceiling is configured with a mesh and a filter mat stacked on the mesh, and air flows downward in the vertical direction from the entire ceiling while the ceiling space is pressurized (for example, see Patent Document 1).

### RELATED ART DOCUMENTS

### Patent Documents

Patent Document 1: Japanese Patent Application Laid-Open No. H8-266988 (FIGS. 1 to 3)

### SUMMARY OF INVENTION

### Problems to be Solved by the Invention

Meanwhile, a coating gun used in a painting booth has a structure in which air called shaping air is blown out so as to atomize paint. In recent years, electrostatic coating guns have been improved to reduce a blowing pressure of the shaping air. In contrast, if a flowing speed of the air flowing down in the painting booth is the same as before, the atomized paint sprayed from the coating gun is blown away downward before attaching to a workpiece. To address this issue, the flow rate of the air flowing down in the painting booth is also reduced in order to reduce the flowing speed of the air. However, there is a problem that when the flow rate of the air is simply reduced in the conventional painting booth, an internal pressure in the ceiling space becomes too low to stably control the flow rate of the air flowing down in the painting booth.

The present invention has been made in view of the above circumstances, and an object of the present invention is to provide a painting booth in which the flow rate of air flowing down in a painting booth can be stably controlled.

### Means of Solving the Problems

In order to achieve the above object, a painting booth according to the present invention is a painting booth having therein a painting treatment area where a workpiece is painted with atomized paint, in which air flows down from an upper part of an inside of the painting booth to remove the atomized paint that is not attached to the workpiece. The painting booth includes a pair of first inner surfaces facing each other in a first horizontal direction with the painting treatment area therebetween, an air supply unit arranged at a center, in the first horizontal direction, of the upper part of the inside, and an air blow-out unit which is formed ranging from a central part to both side parts, in the first horizontal direction, of the air supply unit and which blows out air right downward at the central part and blows out the air in an obliquely downward direction of each of the first inner surfaces on the both side parts.

Further, a painting booth according to the present invention is a painting booth having therein a painting treatment area where a workpiece is painted with atomized paint, in which air flows down from an upper part of an inside of the painting booth to remove the atomized paint that is not attached to the workpiece. The painting booth includes: a side-part surrounding wall which has a cylindrical shape and laterally surrounds the painting treatment area; an air supply unit arranged at a central part of the upper part of the inside; and an air blow-out unit which is formed on the air supply unit and blows out air right downward at a center of the air supply unit, a blowing direction of air being more inclined toward a side of the side-part surrounding wall as being more distant sideward from the center of the air supply unit.

### BRIEF DESCRIPTION OF THE DRAWINGS

FIG. 1 is a perspective view of a painting booth according to a first embodiment of the present invention;

FIG. 2 is a sectional side view of the painting booth at an intermediate position in a longitudinal direction;

FIG. 3 is a sectional side view of the painting booth at an intermediate position in a transverse direction;

FIG. 4 is a perspective view of an air supply duct;

FIG. 5 is a partially enlarged sectional side view of an air supply unit;

FIG. 6 is a perspective view of a painting booth according to a second embodiment;

FIG. 7 is a sectional side view of a painting booth according to a modified example of the present invention;

FIG. 8 is a partially enlarged sectional side view of an air supply unit according to a modified example of the present invention; and

FIG. 9 is a sectional side view of a painting booth according to a modified example of the present invention.

### MODE FOR CARRYING OUT THE INVENTION

### First Embodiment

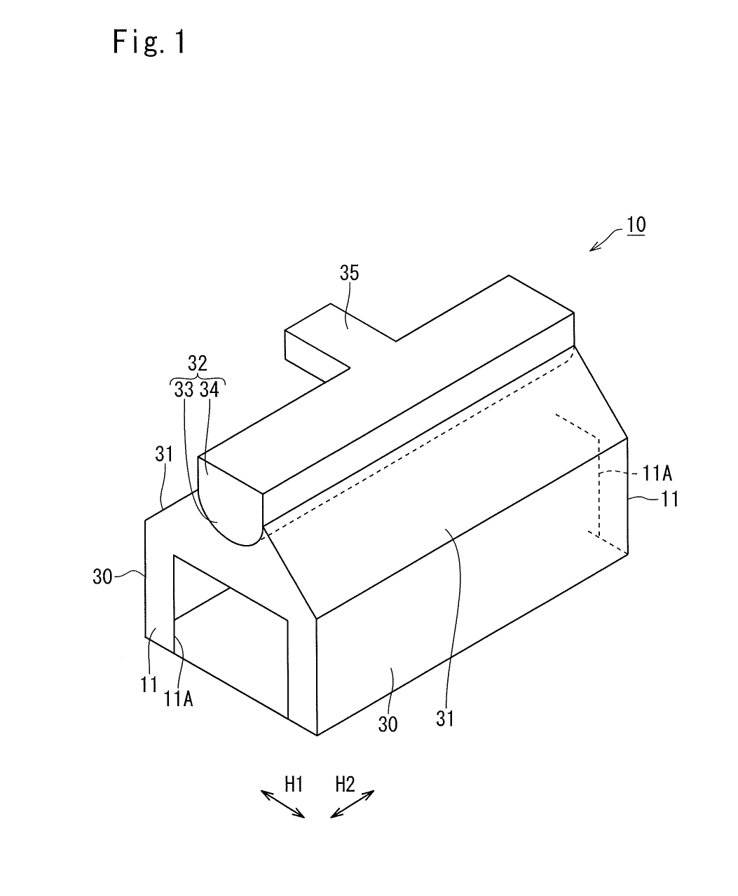

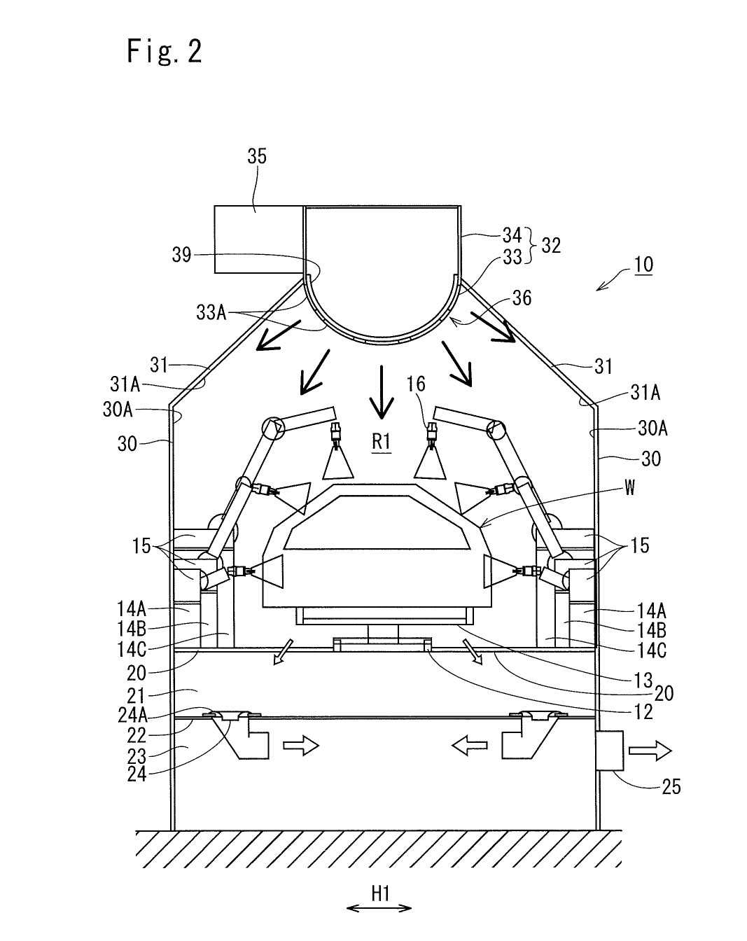

Hereinafter, an embodiment of the present invention will be described with reference to FIGS. 1 to 5. As shown in FIG. 1, a painting booth 10 of the present embodiment has a rectangular planar shape. The transverse direction of the rectangle is a first horizontal direction H1 according to the present invention, and the longitudinal direction of the rectangle is a second horizontal direction H2 according to the present invention. In each of a pair of shorter-side side walls 11 facing each other in the second horizontal direction H2 (longitudinal direction) in the painting booth 10, each of carry-in/out ports 11A and 11A is formed. Further, a conveyance passage 12 shown in FIG. 2 passes through the both carry-in/out ports 11A and 11A, and a conveyor carriage 13 carrying a workpiece W such as a vehicle body moves in one direction on the conveyance passage 12 and passes inside the painting booth 10.

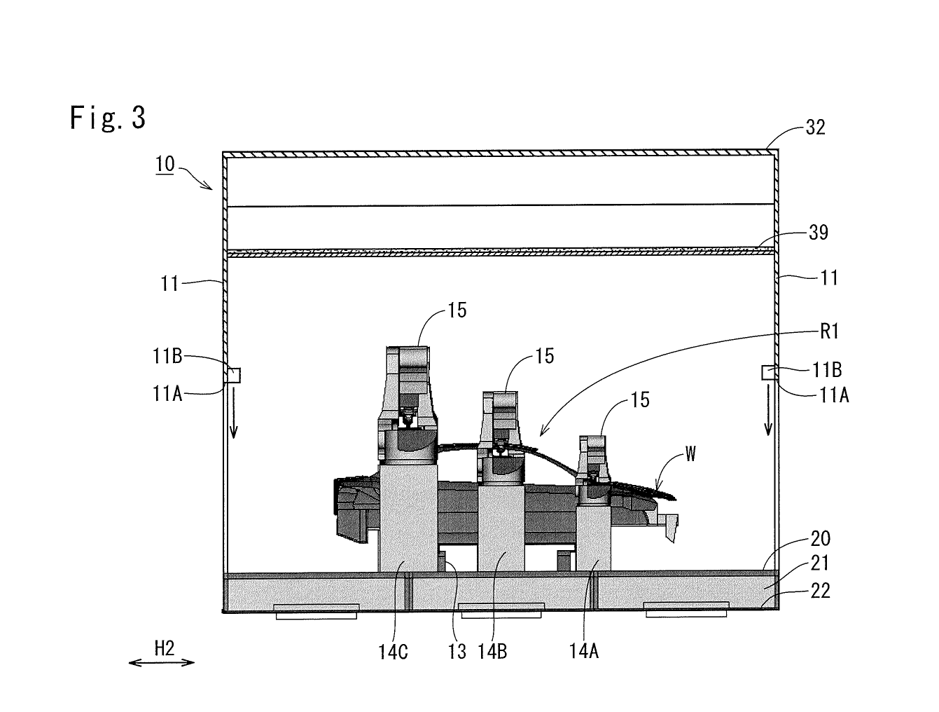

On an upper opening edge of each carry-in/out port 11A in the painting booth 10, an air curtain generator 11B (see FIG. 3) having, for example, a plurality of air nozzles laterally arranged is attached, so that the carry-in/out port 11A is covered by an air curtain.

As shown in FIG. 2, duckboards 20 are provided on the both sides of the conveyance passage 12 in the painting booth 10. On the duckboards 20, a plurality of support platforms 14A, 14B, and 14C having different sizes of large, medium, and small are provided as shown in FIG. 3. A coating robot 15 is mounted on each of the support platforms 14A, 14B, and 14C, and the workpiece W is painted in a painting treatment area R1 surrounded by the group of coating robots 15.

Specifically, the support platforms 14A, 14B, and 14C each have, for example, a pillar shape extending straight in the vertical direction, and are arranged at intervals in the second horizontal direction H2 while being adjacent to a pair of longer-side side walls 30 and 30 of the painting booth 10 in the first horizontal direction H1 as shown in FIG. 2. Further, each coating robot 15 is a so-called vertical articulated robot and is serially equipped with a first arm, a second arm, and a wrist on a horizontally rotatable pivot base. An electrostatic coating gun 16 is mounted on the top end part of the wrist. The coating gun 16 has the same structure as, for example, one disclosed in Japanese Patent Application Laid-Open No. 2013-166113 and sprays atomized paint in a charged state so that the atomized paint is attached to the workpiece W by using attraction force of static electricity.

An underfloor room 21 is formed below the duckboards 20, and further below the underfloor room 21, a suction room 23 which is separated from the underfloor room 21 by an underfloor separation plate 22 is formed. Further, a plurality of communication holes 24 are formed in the both side parts, in the first horizontal direction H1, of the underfloor separation plate 22, and an annular ridge 24A protrudes upward from the opening edge of each of the communication holes 24. Then, air is suctioned through an exhaust duct 25 communicated to the suction room 23 while water is reserved on the upper surface of the underfloor separation plate 22, up to the height of the annular ridge 24A. A flow rate of the air being suctioned is approximately the same as the flow rate of air blown out into the painting booth 10 from an air supply duct 32 which will be described later.

As shown in FIG. 2, an upper part of the inside of the painting booth 10 is configured to have the air supply duct 32, which corresponds to an “air supply unit” of the present invention, between a pair of inclined roofs 31 and 31. The pair of inclined roofs 31 and 31 each have a flat plate shape and are inclined such that the inclined roofs 31 and 31 are raised from the upper end parts of the pair of longer-side side walls 30 and 30 toward the position close to the center, in the first horizontal direction H1, of the painting booth 10. Further, a pair of first inclined ceiling surfaces 31A and 31A of the present invention and a pair of first inner surfaces 30A and 30A of the present invention intersect each other at an angle of, for example, approximately 45 degrees. The first inclined ceiling surfaces 31A and 31A are inner surfaces of the pair of inclined roofs 31 and 31, and the first inner surfaces 30A and 30A are inner surfaces of the pair of longer-side side walls 30 and 30.

A cross-section of the air supply duct 32 has a shape in which the lower side of a horizontally elongated rectangle is swollen downward in a semicircular shape. That is, the air supply duct 32 is structured to have a semicircular arc part 33 (corresponding to a “bay-shaped duct wall” of the present invention) under the rectangular part 34 of a horizontally elongated rectangular shape. Further, a boundary part between the rectangular part 34 and the semicircular arc part 33 is just positioned at, for example, the upper end parts of the inclined roofs 31 and 31. The semicircular arc part 33 is projected downward in the painting booth 10, and the rectangular part 34 is projected above the painting booth 10.

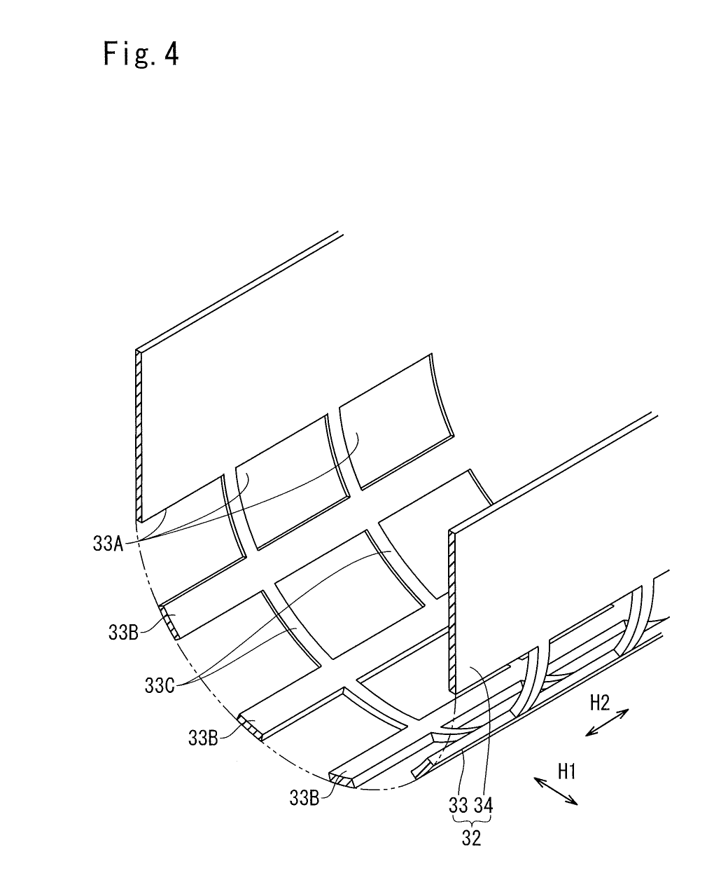

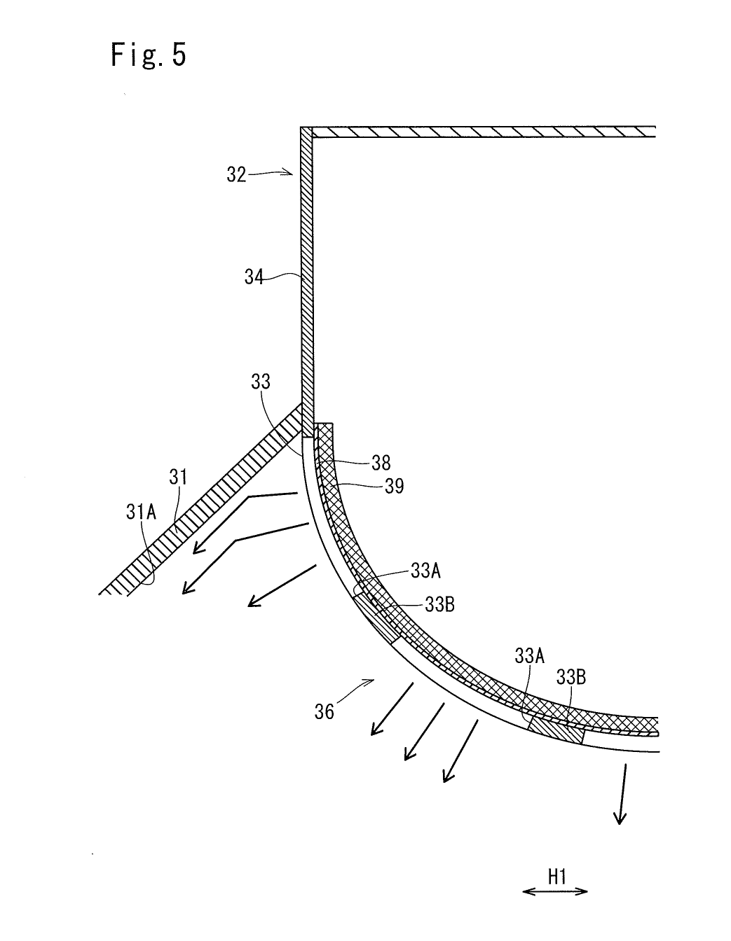

As shown in FIG. 4, a plurality of communication ports 33A are formed in an entire part of the semicircular arc part 33. Specifically, for example, the semicircular arc part 33 is provided with the rectangular communication ports 33A formed arranged in the circumferential direction of the semicircular arc part 33 and the longitudinal direction of the semicircular arc part 33. Thus, the entire semicircular arc part 33 has a structure in which a plurality of longitudinal belt parts 33B extending in the second horizontal direction H2 are arranged in the circumferential direction of the semicircular arc part 33 and are connected by a plurality of lateral belt parts 33C extending in the circumferential direction of the semicircular arc part 33. Further, as shown in FIG. 5, a mesh 38 is laid on the entire part of the inner surface of the semicircular arc part 33, and on the inside of the mesh 38, a filter mat 39 is laid in an overlapping manner, so that approximately whole of the semicircular arc part 33 serves as an air blow-out unit 36 according to the present invention.

In the present embodiment, an “air-permeable pressure reduction member” according to the present invention is configured with the mesh 38 and the filter mat 39.

Further, as shown in FIG. 1, an introduction part 35 is provided approximately at the center, in the longitudinal direction, of one side surface of the rectangular part 34, and an air conditioner (not shown) is connected to the introduction part 35. The air conditioner conditions air, in which external air is mixed with air suctioned through the exhaust duct 25 described above, to a predetermined humidity and temperature through heating, cooling, humidifying, or other treatments, and then feeds the air to the rectangular part 34.

The configuration of the painting booth 10 of the present embodiment is described above. Next, an operation and effect of the painting booth 10 will be described. When the painting booth 10 is made to operate, compressed air is fed from the air conditioner to the air supply duct 32 corresponding to an “air supply unit” of the present invention, and thus an internal pressure of the air supply duct 32 is increased, whereby air is blown out from the entire air blow-out unit 36, which is a lower side semicircular part of the air supply duct 32, at a flow rate corresponding to the internal pressure.

In this operation, the air is blown out in the direction where the air blow-out unit 36 receives the internal pressure, in other words, in the normal vector direction at each position of the air blow-out unit 36. Further, since the air blow-out unit 36 has a circular arc shape, a blowing direction of the air is vertically downward at the center, in the width direction, of the air blow-out unit 36 (also at the center, in the width direction, of the air supply duct 32), and the angle, in the blowing direction, of the air becomes gradually larger as being more distant from the center in the width direction toward the side. This enables the air to flow down from the air blow-out unit 36 in a radial manner, and it is possible to prevent or reduce generation of a windless area in the painting treatment area R1. The air is eventually suctioned down below the duckboards 20.

Further, the air blown out sideward from the both side parts of the air blow-out unit 36 flows obliquely downward while being guided by the first inclined ceiling surfaces 31A as shown in FIG. 5, and reaches the first inner surfaces 30A, which are the inner surfaces of the longer-side side walls 30, as shown in FIG. 2 to be directed downward in the vertical direction. Then, the air passes around the coating robots 15 and the support platforms 14A, 14B, and 14C, and is suctioned down below the duckboards 20. By this operation, the atomized paint around the coating robots 15 and the support platforms 14A, 14B, and 14C is reliably suctioned down below the duckboards 20, and the paint is prevented from attaching to the first inner surfaces 30A.

In the painting booth 10 of the present embodiment, the air supply duct 32 corresponding to the “air supply unit” of the present invention is arranged on a part (center) of the upper part of the inside, not on the entire upper part of the inside. Thus, the air supply unit, in other words, the capacity of the inside of the air supply duct 32 can be smaller than the conventional painting booth in which the entire upper part of the inside is the air supply unit. With this, even if the flow rate of the air flowing down in the painting booth 10 from the air blow-out unit 36 is made smaller, the internal pressure in the air supply duct 32 does not excessively decrease like before, whereby it is possible to stably control the flow rate of air. That is, it is possible to make air stably flow at such a flow speed that the air flow does not prevent atomized paint from attaching to a workpiece, and high-quality painting can be achieved by a coating gun 16 having a relatively low blowing pressure of shaping air.

### Second Embodiment

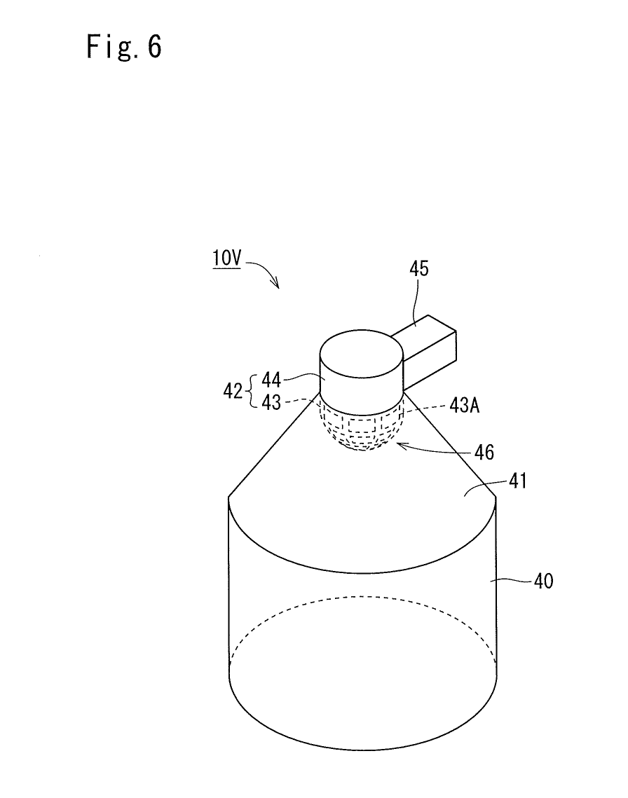

A painting booth 10V of the present embodiment is shown in FIG. 6 and is configured to be equipped with a conical ceiling wall 41 of a conical shape on the upper side of a side-part surrounding wall 40 of a cylindrical shape, and is equipped with an air supply duct 42 at the central part of the conical ceiling wall 41. The air supply duct 42 is configured such that a hemispherical body 43 (corresponding to a “container-shaped curved wall” of the present invention) is connected to the lower end part of a cylindrical body 44. For example, a boundary part between the cylindrical body 44 and the hemispherical body 43 is fit in the upper end part of the conical ceiling wall 41. An introduction part 45 is formed in the cylindrical body 44, and an air conditioner (not shown) is connected to the introduction part 45. In the hemispherical body 43, a plurality of communication ports 43A are perforated. The communication ports 43A are covered by a mesh and filter mat (not shown), so that the whole of the hemispherical body 43 serves as an air blow-out unit 46 according to the present invention, and air flows down in a radial manner.

Also in the painting booth 10V of the present embodiment, the air supply duct 42 serving as the “air supply unit” of the present invention is arranged on a part of the upper part of the inside. Thus, the capacity of the inside of the air supply unit can be smaller than the conventional painting booth in which the entire upper part of the inside serves as the air supply unit. With this arrangement, even if the flow rate of the air flowing down in the painting booth 10V from the air blow-out unit 46 is made smaller, the internal pressure of the air supply duct 42 does not excessively decrease like before, whereby it is possible to stably control the flow rate of air. That is, it is possible to make air stably flow at such a flow speed that the air flow does not prevent atomized paint from attaching to a workpiece, and high-quality painting can be achieved by a coating gun 16 having a relatively low blowing pressure of shaping air. Further, since the conical ceiling wall 41 is provided on a surrounding area of the air blow-out unit 46 in the upper part of the inside of the painting booth 10V, air flows down smoothly on the side-part surrounding wall 40 while being guided by the conical ceiling wall 41, so that the air flow can prevent paint from attaching to the side-part surrounding wall 40 and a coating robot (not shown) adjacent to the inner side of the side-part surrounding wall 40.

### Other Embodiments

The present invention is not limited to the above embodiments, and, for example, embodiments described below are also included in the technical scope of the present invention. Further besides the embodiments below, the present invention can be variously modified and practiced without departing from the spirit of the invention.

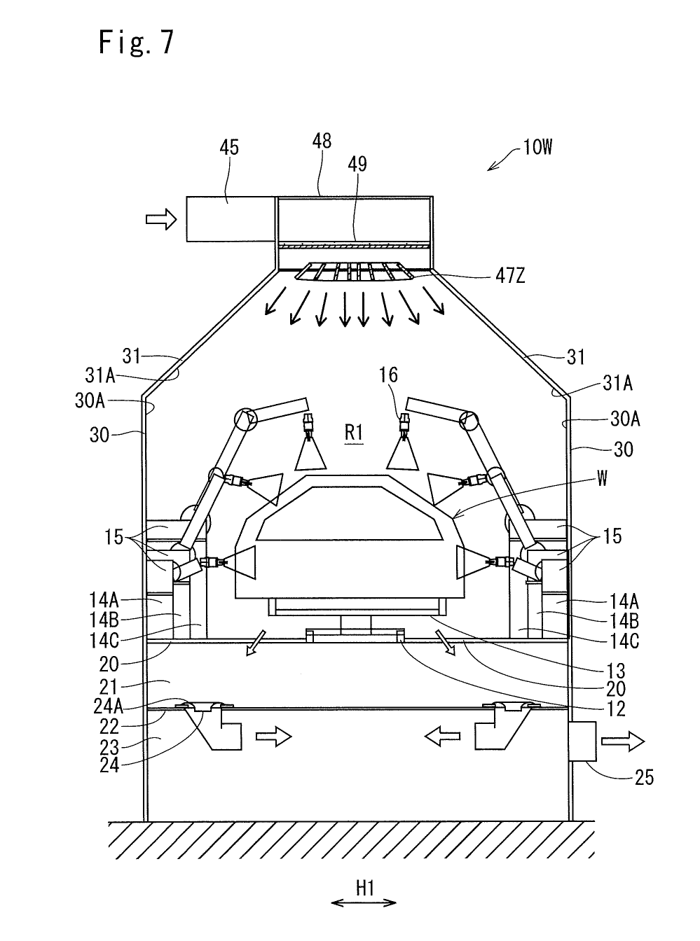

(1) In the painting booth 10 of the first embodiment, a part of the air supply duct 32 corresponding to the “air supply unit” is arranged between the upper end parts of the inclined roofs 31 and 31. However, as the painting booth 10W shown in FIG. 7, an air supply duct 48 having a rectangular cross-section may be provided as the “air supply unit” above the inclined roofs 31 and 31, and the entire part of the flat lower surface of the air supply duct 48 may be used as an aeration part 49 made up of a mesh and a filter mat. In addition, below the aeration part 49, a plurality of air vent deflectors 47Z extending in the longitudinal direction of the air supply duct 48 may be arranged in the width direction of the air supply duct 48. Even with this configuration, if the inclination angles of the plurality of air vent deflectors 47Z are made different such that the direction of wind is directed more sideward as being more distant sideward from the center of the air supply duct 48, the same advantageous effects can be obtained as in the first embodiment.

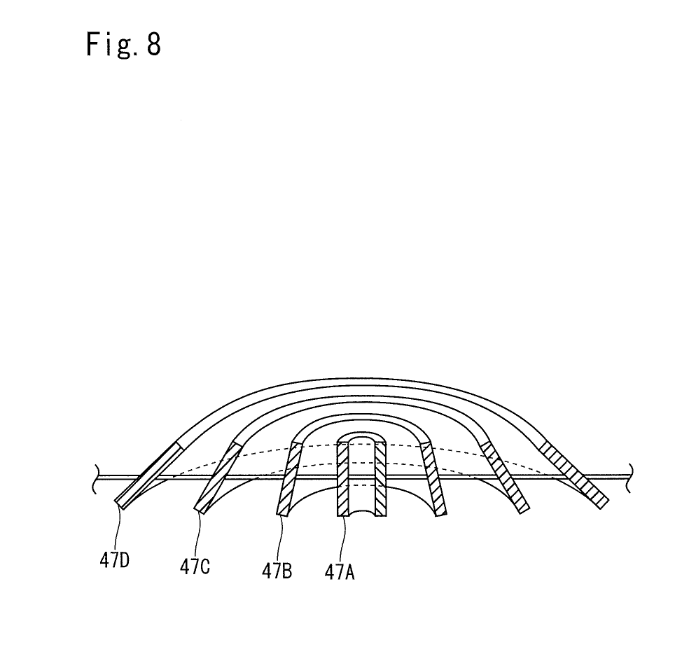

(2) Further, in the painting booth 10V of the second embodiment shown in FIG. 6, the lower part of the air supply duct 42 corresponding to the “air supply unit” is the hemispherical body 43. However, without providing the hemispherical body 43, the flat lower surface of the cylindrical body 44 may serve as an aeration part (not shown) made up of a mesh and a filter, and a plurality of annular air vent deflectors 47A to 47D shown in FIG. 8 may be concentrically arranged below the aeration part. Even with this configuration, if the inclination angles of the plurality of air vent deflectors 47A to 47D are made different such that the direction of wind is directed more sideward as being more distant sideward from the center of the cylindrical body 44, the same advantageous effects can be obtained as in the second embodiment.

(3) Inside the air supply duct 32 of the first embodiment, an air passing part may be provided in which a mesh is stretched to separate the semicircular arc part 33 from the rectangular part 34 and in which a filter mat is stacked on the mesh. With this configuration, in the entire inside of the semicircular arc part 33, the internal pressure is more uniform, and the flow rate of the air blown out from the air blow-out unit 36 is stable.

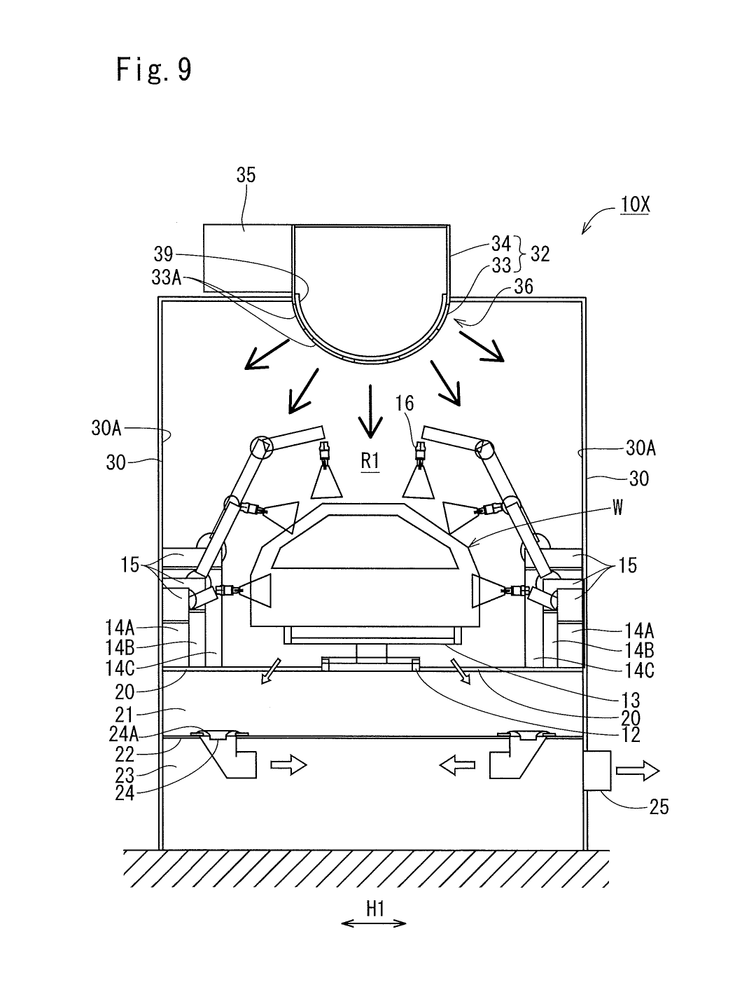

(4) In the first and second embodiments, the side parts of the air supply ducts 32 and 42 in the upper part of the inside of the painting booths 10 and 10V are inclined as the inclined roof 31 and the conical ceiling wall 41. However, the side parts of the air supply ducts 32 and 42 in the upper part of the inside may be horizontal as the painting booth 10X shown in FIG. 9.

(5) The air blow-out units 36 and 46 of the first and second embodiments are configured such that air passes through at any positions on the air blow-out units 36 and 46 at the same pressure loss. However, for example, the air blow-out units 36 and 46 may be configured such that the pressure loss is greater at the central part than at the side part, and air may be blown out at different flow rates depending on the position on the air blow-out units 36 and 46.

(6) In each of the above embodiments, an air-permeable pressure reduction member according to the present invention is configured with a mesh and a filter mat. However, only a mesh or a filter mat can be used, and anything other than a mesh and a filter mat can also be used if air can pass therethrough while losing pressure.

### DESCRIPTION OF THE REFERENCE NUMERAL

10, 10V, 10W, 10X: Painting booth
30A: First inner surface
31: Inclined roof
31A: First inclined ceiling surface
32, 42, 48: Air supply duct (air supply unit)
33: Semicircular arc part
36, 46: Air blow-out unit
38: Mesh (air-permeable pressure reduction member)
39: Filter mat (air-permeable pressure reduction member)
40: Side-part surrounding wall
41: Conical ceiling wall
47A to 47D, 47Z: Air vent deflector
H1: First horizontal direction
H2: Second horizontal direction
R1: Painting treatment area
W: Workpiece

1-7. (canceled)

8. A painting booth having therein a painting treatment area where a workpiece is painted with atomized paint, in which air flows down from an upper part of an inside of the painting booth to remove the atomized paint that is not attached to the workpiece, the painting booth comprising:
a pair of first inner surfaces facing each other in a first horizontal direction with the painting treatment area sandwiched therebetween;
an air supply duct arranged at a center, in the first horizontal direction, of the upper part of the inside; and
an air blow-out port which is formed ranging from a central part to both side parts, in the first horizontal direction, of the air supply duct, and which blows out air right downward at the central part and blows out the air in an obliquely downward direction of each of the first inner surfaces on the both side parts.

9. The painting booth according to claim 8, wherein an angle between a blowing direction of the air from the air blow-out port and a vertical direction becomes gradually larger as being more distant sideward from the central part, in the first horizontal direction, of the air supply duct.

10. The painting booth according to claim 8, wherein
the painting booth has a planar rectangular shape which is longer in a second horizontal direction perpendicular to the first horizontal direction than in the first horizontal direction,
the air supply duct is extending in the second horizontal direction and is provided with a bay-shaped duct wall which is curved or bent to extend gradually downward from both side parts toward a center, in a width direction, of the air supply duct, and
the air blow-out port is configured with a plurality of openings perforated in an approximately entire part of the bay-shaped duct wall, which are covered by a filter or a mesh.

11. The painting booth according to claim 9, wherein
the painting booth has a planar rectangular shape which is longer in a second horizontal direction perpendicular to the first horizontal direction than in the first horizontal direction,
the air supply duct is extending in the second horizontal direction and is provided with a bay-shaped duct wall which is curved or bent to extend gradually downward from both side parts toward a center, in a width direction, of the air supply duct, and
the air blow-out port is configured with a plurality of openings perforated in an approximately entire part of the bay-shaped duct wall, which are covered by a filter or a mesh.

12. The painting booth according to claim 8, comprising
a pair of first inclined ceiling surfaces each provided on each of both sides of the air supply duct in the upper part of the inside, each of the first inclined ceiling surfaces being inclined downward from the air supply duct to an upper end part of each of the pair of first inner surfaces.

13. The painting booth according to claim 9, comprising
a pair of first inclined ceiling surfaces each provided on each of both sides of the air supply duct in the upper part of the inside, each of the first inclined ceiling surfaces being inclined downward from the air supply duct to an upper end part of each of the pair of first inner surfaces.

14. The painting booth according to claim 10, comprising
a pair of first inclined ceiling surfaces each provided on each of both sides of the air supply duct in the upper part of the inside, each of the first inclined ceiling surfaces being inclined downward from the air supply duct to an upper end part of each of the pair of first inner surfaces.

15. The painting booth according to claim 11, comprising
a pair of first inclined ceiling surfaces each provided on each of both sides of the air supply duct in the upper part of the inside, each of the first inclined ceiling surfaces being inclined downward from the air supply duct to an upper end part of each of the pair of first inner surfaces.

16. A painting booth having therein a painting treatment area where a workpiece is painted with atomized paint, in which air flows down from an upper part of an inside of the painting booth to remove the atomized paint that is not attached to the workpiece, the painting booth comprising:
a side-part surrounding wall which has a cylindrical shape and laterally surrounds the painting treatment area;
an air supply duct arranged at a central part of the upper part of the inside; and
an air blow-out port which is formed on the air supply duct and blows out air right downward at a center of the air supply duct, a blowing direction of the air being more inclined toward a side of the side-part surrounding wall as being more distant sideward from the center of the air supply duct.

17. The painting booth according to claim 16, wherein
the air supply duct is provided with a container-shaped curved wall that is swelled downward, and
the air blow-out port is configured with a plurality of openings perforated in an approximately entire part of the container-shaped curved wall, which are covered by a filter or a mesh.

18. The painting booth according to claim 16, comprising
a conical ceiling surface that is inclined such that the conical ceiling surface is narrowed from an entire part of an upper end of side-part surrounding wall toward above a central part of the side-part surrounding wall, wherein
the air supply duct is surrounded by the conical ceiling surface.

19. The painting booth according to claim 17, comprising
a conical ceiling surface that is inclined such that the conical ceiling surface is narrowed from an entire part of an upper end of side-part surrounding wall toward above a central part of the side-part surrounding wall, wherein
the air supply duct is surrounded by the conical ceiling surface.
